(19) United States
(12) Patent Application Publication
(10) Pub. No.: US 2006/0097996 A1
(43) Pub. Date: May 11, 2006

(54) Input device

(75) Inventor: Masashi Tabata, Fukushima-ken (JP)

Correspondence Address: BRINKS HOFER GILSON & LIONE, P.O. BOX 10395, CHICAGO, IL, 60610, US

(73) Assignee: ALPS ELECTRIC CO., LTD.

(21) Appl. No.: 11/271,239

(22) Filed: Nov. 3, 2005

(30) Foreign Application Priority Data
Nov. 10, 2004 (JP) 2004-326371
Jan. 31, 2005 (JP) 2005-022459

(51) Int. Cl. G09G 5/00

(52) U.S. Cl. 345/173

(57) ABSTRACT

An input device is presented. The input devices contains a chassis having an opening. A detecting unit has a surface panel exposed through the opening and detects a pressing operation when the surface panel is pressed. An exciting unit vibrates the surface pane. A driving unit generates driving signals driving the exciting unit at predetermined frequencies. A control unit supplies starting signals starting the driving unit on the basis of an output from the detecting unit. The detecting unit is supported by two supporting portions provided at edge portions of the opening and has a free-end portion at the outside of one of the supporting portions and the exciting unit provided at the free-end portion.

### BACKGROUND OF THE INVENTION

1. Field of the Invention

The present invention relates to an input device that generates vibrations as a response to an input operation on a touch panel, and in particular, to an input device that can efficiently generate vibrations and supply large vibrations throughout the touch panel as an input response.

2. Description of the Related Art

Hereinafter, description of related arts will be illustrated below. JP-A-11-85400 discloses a display device in the related art, on which an input operation can be performed.

FIG. 10 is an exploded perspective view showing the display device. When a pen 200 touches a display panel 201, position-detecting data representing the positions of the pen 200 are outputted to a control circuit 203 from a position sensor sheet 202.

The control circuit 203 verifies the position-detecting data and the position data of specific images (object) displayed on the display panel 201 and determines vibrations corresponding to the object on the basis of a predetermined algorithm when both data coincide.

In addition, the control circuit 203 outputs control signals corresponding to the determined vibrations to a signal-converting circuit 204. The signal-converting circuit 204 outputs driving signals on the basis of the control signals to a vibrating element 205. Then, the vibrating element 205 works and the display panel 201 vibrates, thereby the vibrations are transmitted via the pen 200 to an operator gripping the pen 200.

As the following related arts, FIG. 11 is a plane view of an input device in the related art, which is seen from a surface panel, and FIG. 12 is a view showing driving signals of a vibration-generating device in the related art. Meanwhile, the abscissa t represents time, and the ordinate V represents the voltage of the driving signals.

If an operator presses a display region 13A on the surface panel 13a, a detecting unit provided at the surface panel 13a detects the coordinate data of the pressed region. A control unit of the input device 10 scans the coordinate data from the detecting unit and outputs starting signals to a driving unit driving vibration-generating devices 15A and 15B when determining the operator presses the surface panel 13a. As shown in FIG. 12, the driving unit generates first and second driving signals Sd1 and Sd2 at predetermined frequencies when receiving the starting signals and outputs the first and second driving signals Sd1 and Sd2 to the vibration-generating devices 15A and 15B respectively. In addition, the vibration-generating devices 15A and 15B generate vibrations, and the waves of the vibrations are transmitted to the surface of the surface panel 13a (the surface in the Z1-direction in the drawings). As a result, a click sensation (operating feeling) is fed to the operator as a response to a pressing operation on the surface panel 13a.

JP-A-2002-252895 discloses a transparent flat speaker in the related art. FIG. 13 is a back view showing an exciting mode of the transparent flat speaker in the related art.

In the transparent flat speaker 200, two exciters 201 drive a transparent flat plate in order to generate vibrations, and then the vibrations are amplified. The exciters 201 are provided at long and short side edges 202a and 202b of the transparent flat plate 202.

However, in the invention disclosed by JP-A-11-85400, the vibrating element 205 is fitted into a fixed frame 201a of the display panel 201. That is, the vibrating element 205 is directly fitted into a portion, on which the vibration node of the display panel 201 is formed. As a result, the waveform of the display panel 201 can be disturbed or the vibration amplitude of the display panel 201 easily decreases if the vibrating element 205 does not generate large-amplitude vibrations by a large driving force. Therefore, there is a problem in that the operator cannot securely feel the vibrations as a response to an input operation.

That is, the vibrating element 205 must be a large-sized in order to generate large vibrations, or large power is required since the vibrations cannot be efficiently generated.

In this case, if the vibration-generating device can be provided at a portion forming the antinode of the vibration waveform, large-amplitude vibrations can be generated.

However, the portion forming the antinode of the vibration is located in the middle of the display panel 201, and the vibration-generating device provided in the middle becomes an obstacle to the display, thereby not offering a practical solving method.

Furthermore, in the input device 10 in the related art, the vibration-generating devices 15A and 15B are disposed symmetrically as shown in FIG. 11, and the first driving signals Sd1 of the vibration-generating device 15A and the second driving signals Sd2 of the vibration-generating device 15B are generated at t1 simultaneously, thereby the vibration-generating devices 15A and 15B are driven simultaneously. Therefore, the operator can feel a click sensation when pressing regions 101, 103, and 105 shown in FIG. 11. Herein, the display region 13A is divided into five regions and denoted by region 101, 102, 103, 104, and 105, consecutively, from X1-side to X2-side of the drawings. On the other hand, the waves of the vibrations generated by the vibration-generating devices 15A and 15B interfere with each other in regions 102 and 104, and thus the waves of the vibrations transmitted to the surface of the surface panel 13a are weakened. Therefore, the operator seldom feels a click sensation when pressing the region 102, 104. That is, the input device 10 in the related art includes regions, at which a click sensation can be felt, and regions, at which a click sensation cannot be felt, on the surface panel 13a.

Furthermore, JP-A-2002-252895 does not disclose the driving method of the exciters 201.

### SUMMARY OF THE INVENTION

The present invention has been devised in order to solve the problems of the related arts, and it is an object of the invention to provide an input device capable of vibrating with large amplitude so efficiently that an operator can feel the vibrations throughout a touch panel as an input response.

An input device according to an aspect of the invention includes a chassis having an opening; a detecting unit that has a surface panel exposed through the opening and detects a pressing operation when the surface panel is pressed; an exciting unit that vibrates the surface panel; a driving unit that generates diving signals driving the exciting unit at predetermined frequencies; and a control unit that supplies starting signals starting the driving unit on the basis of an output from the detecting unit. The detecting unit is supported by two supporting portions provided at the edge portions of the opening, and has a free-end portion at the outside of one of the supporting portions and the exciting unit provided at the free-end portion.

In the above aspect, the exciting unit is disposed close to a portion forming an antinode of the vibration waveform of the detecting unit (particularly a display panel). Then, the free-end portion is vibrated. When the free-end portion is vibrated, vibrations forming nodes at the supporting portions and an antinode between the nodes can be generated at the display region which is a part of the detecting unit connected with the free-end portion. Therefore, compared with the input device in the related art, in which the exciting unit is disposed close to a portion forming the node of the vibration waveform, the input device can generate large-amplitude vibrations with a small driving force. Therefore, the operator can securely feel the vibrations (click sensation) as a response to the pressing operation (input operation) on the display region.

It is preferable that the length L1 from the exciting unit-fixed position to the closer node be set to 1/(2n) of the supporting length L, in which λ represents the wavelength of generated vibration, L represents a supporting length between two supporting portions, and a natural number n represents the number of antinodes of vibration formed between the supporting portions.

With the length L1 set like the above, large-amplitude vibrations can be generated for all vibrations having n-multiple frequencies.

Furthermore, in the above case, it is preferable that the vibrations form both nodes at the supporting portions provided at both edge portions of the opening and an antinode between the supporting portions and the length L1 be set to half of the supporting length L.

Still furthermore, in the above aspect, it is preferable that the free-end portion be made by integrally extending the surface panel.

In the above aspect, it is preferable that the display unit be provided at a position facing the detecting unit in the chassis.

The display unit displays images on the basis of the display data fed by the control unit. The images displayed on the display unit can be seen from the outside through the display regions. Therefore, the operator can press the display regions (input operation) while checking the images seen through the detecting unit.

Further, in the above aspect, it is preferable that the detecting unit have a coordinate-detecting unit for detecting the coordinate data of pressed regions when the operator presses the surface panel and the exciting unit be driven when the control unit scans the coordinate data from the coordinate-detecting unit.

With the above composition, when the operator presses display regions, the coordinate data of pressed regions can be detected by the coordinate-detecting unit of the detecting unit.

Furthermore, in the above aspect, it is preferable that the resonance frequency of the exciting unit be set as the same resonance frequency of the surface panel.

With the above actions, large-amplitude vibrations can be generated with a small driving force. Therefore, it is possible to decrease the size of the exciting unit and to suppress the power consumption of the exciting unit. That is, vibrations can be efficiently generated.

In addition, in the above aspect, it is preferable to provide a second exciting unit vibrating the surface panel.

Since various vibrations are generated on the surface panel when the surface panel is excited from a plurality of positions, vibration fluctuation hardly occurs.

Furthermore, in the above aspect, it is preferable that the second exciting unit be provided at the free-end portion outside the supporting portion.

Of course, it is more effective to dispose the second exciting unit at the free-end portion as like the first exciting unit.

Still furthermore, in the above aspect, it is preferable that the driving unit generate first driving signals driving the first exciting unit and second driving signals driving the second exciting unit, the first and second driving signals be generated with time differentiation, and the control unit be provided to drive the first and second exciting units with time differentiation.

In the above aspect, the first and second driving signals are generated with time differentiation, and the first and second exciting units are driven with time differentiation. Therefore, the phases of vibrations generated by the first and second exciting units and transmitted to the surface panel are staggered, and the nodes and antinodes are properly dispersed in the waves of vibrations, thereby the waves of the vibrations are securely transmitted throughout the surface panel. As a result, the operator can feel a click sensation throughout the surface panel as a response to an input operation on the surface panel.

Still furthermore, in the above aspect, it is preferable that the surface panel be rectangular, the first exciting unit be disposed along one of two end sides intersecting perpendicularly with each other in the surface panel, and the second exciting unit be disposed along the other end side.

As described above, when the first and second exciting units are disposed at the end sides intersecting perpendicularly, the waves of the vibrations generated by the first and second exciting units are interfered and transmitted securely throughout the surface panel. As a result, the operator can feel a click sensation throughout the surface panel as a response to an input operation on the surface panel.

Still furthermore, in the above aspect, it is preferable that the surface panel has long and short sides, the first exciting unit be disposed along the short side, and the second exciting unit be disposed along the long side and away from the first exciting unit at the center of the long side.

Then, the waves of the vibrations generated by the first and second exciting units are transmitted more securely throughout the surface panel. As a result, the operator can feel a click sensation more securely throughout the surface panel as a response to an input operation on the surface panel.

Still further, in the above aspect, it is preferable that the second driving signals be generated when a predetermined delay time T elapses after the first driving signals are generated and the delay time T be in the range of t0/2≦T ≦t0, in which t0 represents the time required for the wave, which is generated by the first exciting unit driven by the first driving signals and transmitted to the surface panel from the first exciting unit, to travel from the first exciting unit-provided at the end side to the opposite end side thereof.

When the delay time is set as like the above, the waves of the vibrations generated by the first and second exciting units are transmitted more securely throughout the surface panel. As a result, the operator can feel a click sensation throughout the surface panel as a response to an input operation on the surface panel.

### BRIEF DESCRIPTION OF THE DRAWINGS

FIG. 1 is a block diagram showing the composition of a first embodiment of an input device according to the present invention;

FIG. 2 is a plane view of the input device of the first embodiment seen from a panel;

FIG. 3 is an enlarged cross-sectional view taken along line 3-3 in FIG. 2;

FIG. 4 is an explanatory view showing the vibrations of the surface panel of the input device of the first embodiment;

FIG. 5 is an explanatory view showing the relationship between length L1 to an exciting unit-fixed position and supporting length L by the types of vibration;

FIG. 6 is a block diagram showing the composition of a second embodiment of the input device according to the invention;

FIG. 7 is a cross-sectional view of the input device of the second embodiment taken along line 2-2 in FIG. 11;

FIG. 8 is a view showing driving signals fed to a vibration-generating unit of the second embodiment;

FIG. 9 is the same type of plane view as FIG. 11 showing a varied embodiment of the input device of the second embodiment;

FIG. 10 is an exploded perspective view showing a display unit in the related art;

FIG. 11 is a plane view of an input device in the related art seen from the surface panel;

FIG. 12 is a view showing the driving signals of a vibration-generating unit in the related art; and

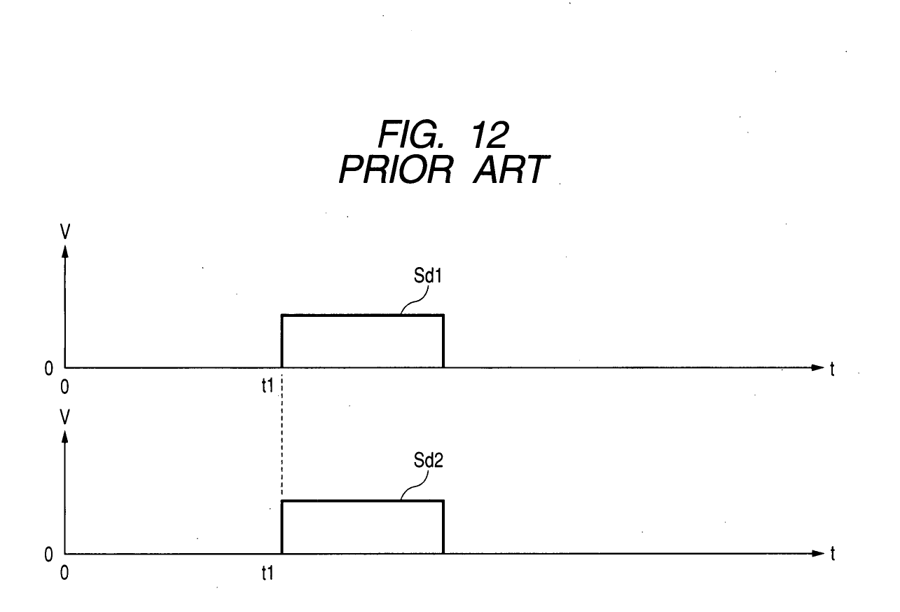

FIG. 13 is a back view showing the exciting mode of a transparent flat speaker in the related art.

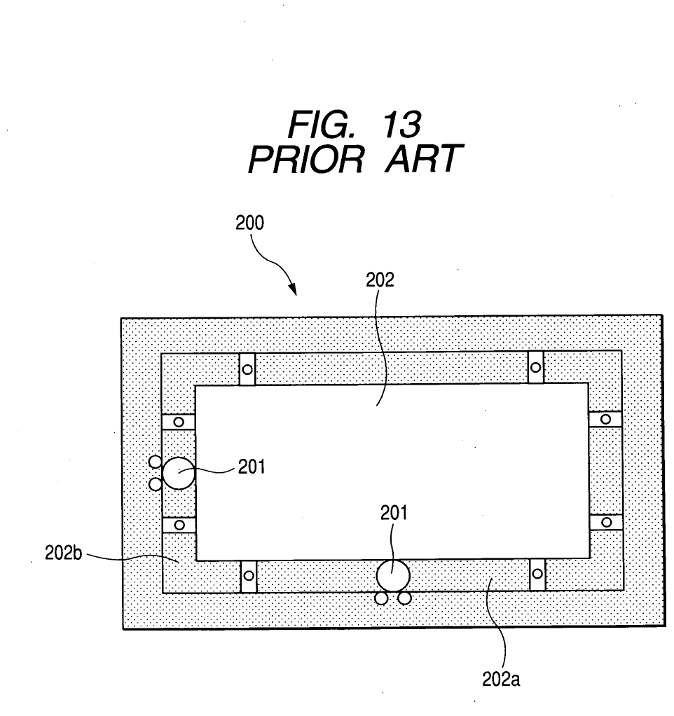

### DESCRIPTION OF THE PREFERRED EMBODIMENT

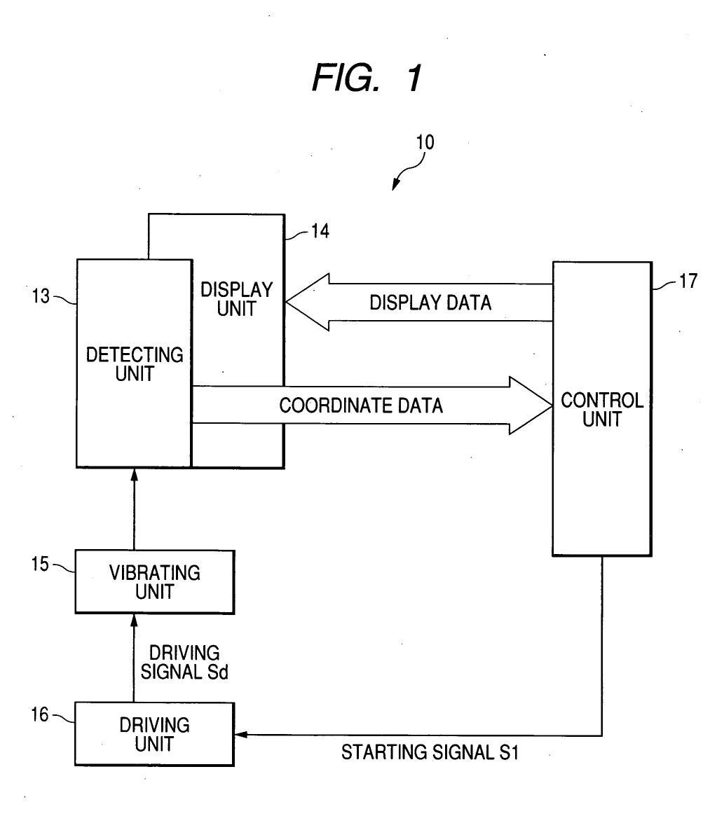

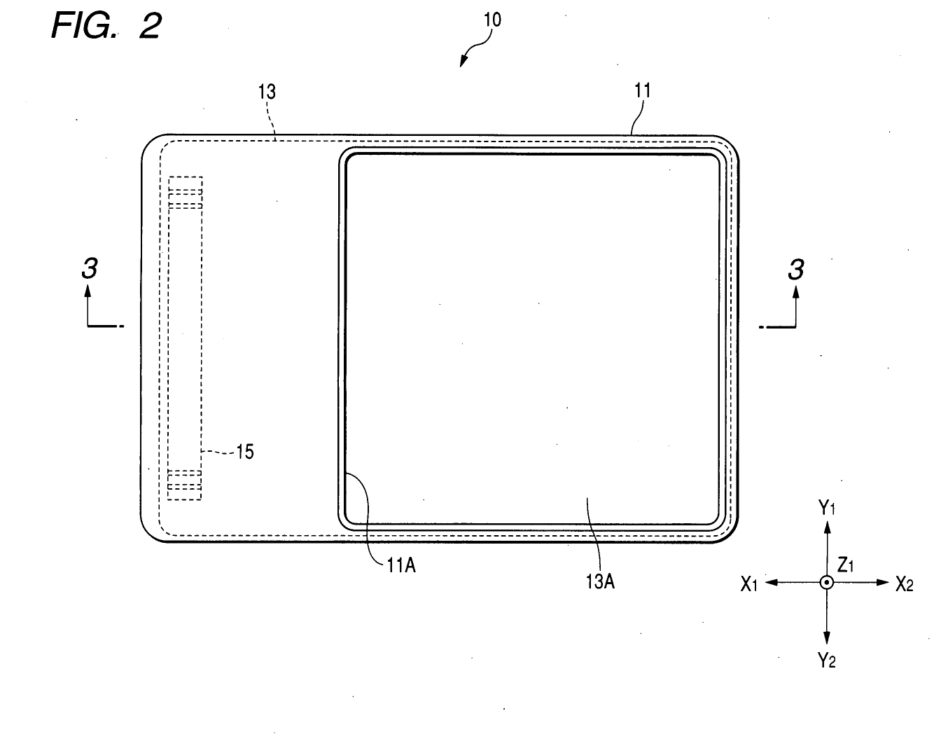

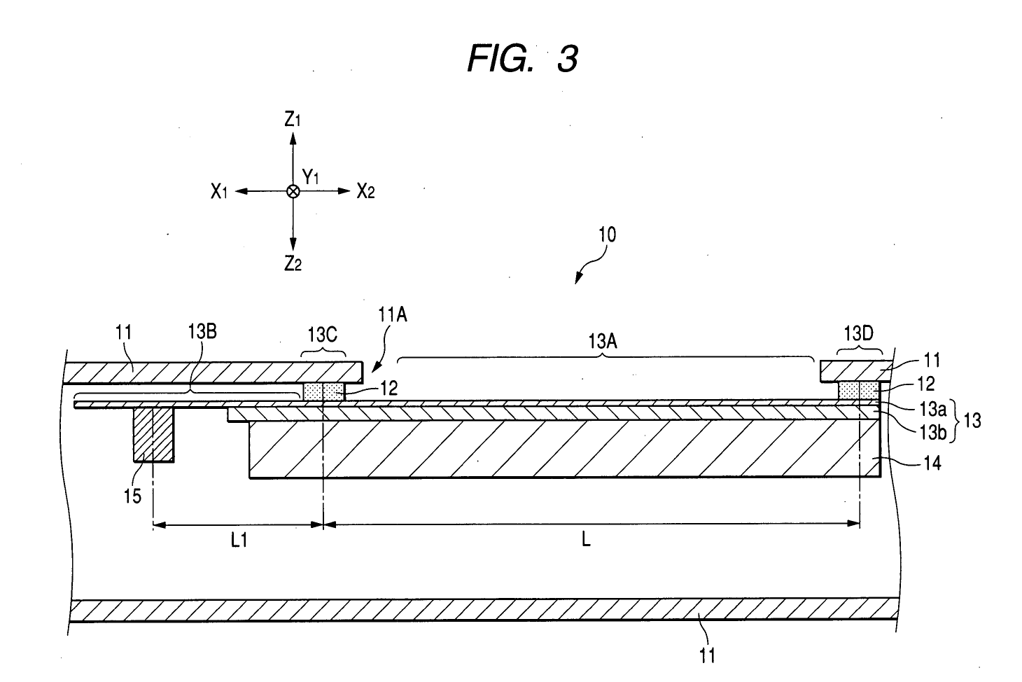

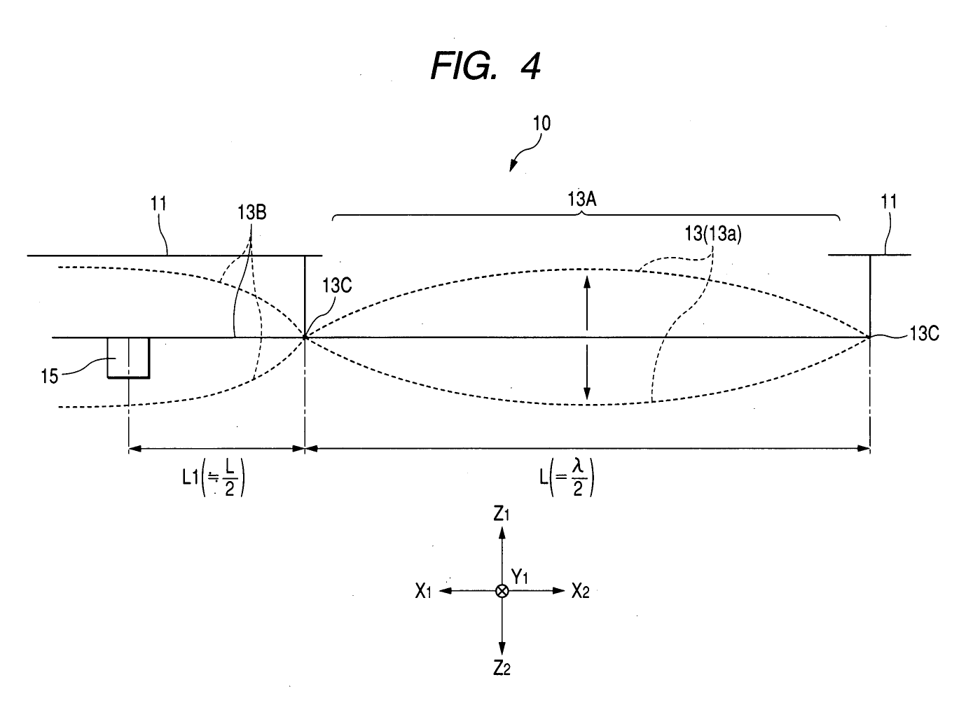

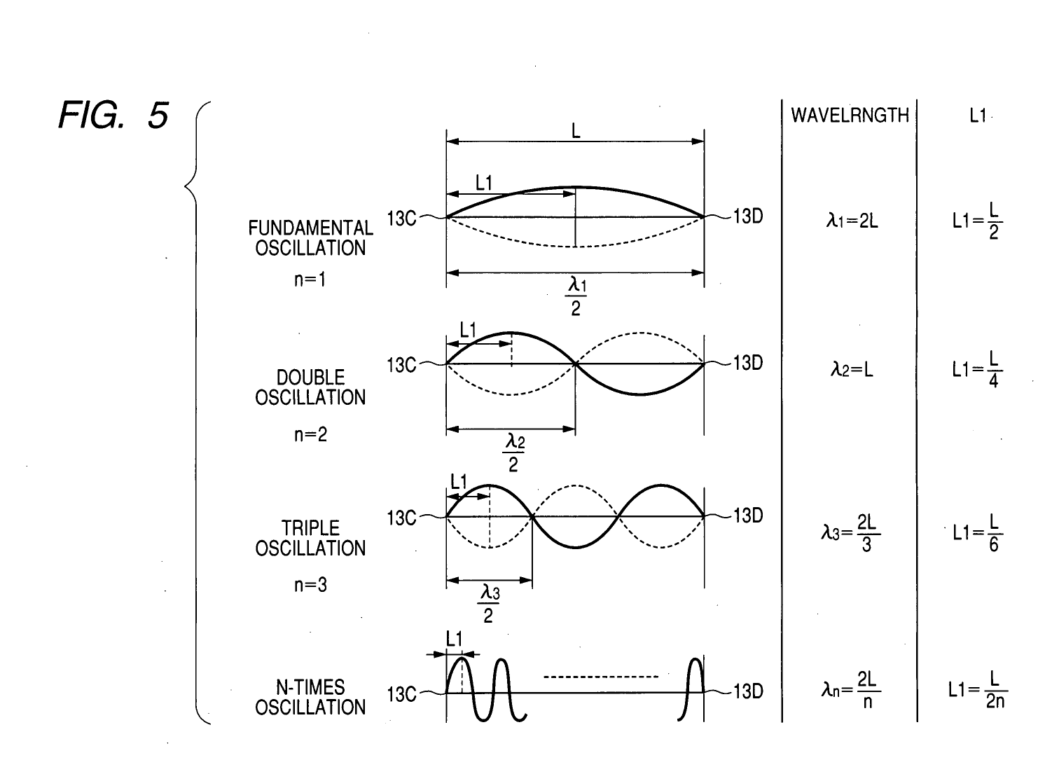

FIG. 1 is a block diagram showing the composition of a first embodiment of an input device according to the present invention, FIG. 2 is a plane view of the input device of the first embodiment seen from a panel, FIG. 3 is an enlarged cross-sectional view taken along line 3-3 in FIG. 2, FIG. 4 is an explanatory view showing the vibrations of the surface panel of the input device of the first embodiment, and FIG. 5 is an explanatory view showing the relationship between the length L1 to an exciting unit-fixed position and the supporting length L by the types of vibration.

An input device 10 will be described below by extracting a touch panel used for, for example, an automatic telling machine (ATM), an automatic ticketing machine or various portable input devices.

As shown in FIG. 1, the input device 10 includes a detecting unit 13, a display unit 14, an exciting (vibrating) unit 15, a driving unit 16, a control unit 17 or the like.

As shown in FIG. 2, the input device 10 has a chassis 11, and a rectangular, for example, opening 11A is formed at the chassis 11. A touch panel-type detecting unit 13 is provided at the lower surface (the surface in the Z2-direction of the drawings) of the chassis 11, and a display region 13A (the surface in the Z1-direction of the drawings), a part of the detecting unit 13, is exposed through the opening 11A.

As shown in FIG. 3, the detecting unit 13 has a surface panel 13a, which is made of transparent glass, plastic or the like and provided usually at the uppermost layer, and a coordinate-detecting unit 13b provided right below the surface panel 13a. The coordinate-detecting unit 13b is, for example, a film on glass, electromagnetic coupling or capacitive type unit, and the detecting unit 13 has great optical transmittance.

Elastic supporting members 12 made of rubber or the like are provided at the circumferential edges of the opening 11A in the lower surface of the chassis 11, and the surface panel 13a is fixed to the lower surfaces of the elastic supporting members 12. That is, the detecting unit 13 is elastically supported by the opening 11A through the elastic supporting members 12.

In addition, the display region 13A of the detecting unit 13 is exposed to the outside through the opening 11A of the chassis 11, thereby an operator can press the surface panel 13a corresponding to the display region 13A by an operating body such as finger, operating pen or the like.

Portions supported by the elastic supporting members 12 at the edges of the display region 13A form supporting portions 13C and 13D, and a free-end portion 13B, which protrudes outward from the supporting portion 13C (in the X1-direction of the drawings), is provided at an edge of the display region 13A under the chassis 11.

A display unit 14 consisting of FPD (flat panel display) or the like is disposed under the display region 13A of the detecting unit 13. When the control unit 17 supplies various display data, the display unit 14 displays images on the basis of the display data. In addition, the images displayed on the display unit 14 can be seen from the outside through the display region 13A. Therefore, the operator can press the display regions (input operation) while checking the images seen through the detecting unit.

The exciting unit 15 is fixed to the lower surface of the free-end portion 13B of the detecting unit 13, more preferably, of the surface panel 13a. Herein, it is preferable that the length L1 from a node closest to the free-end portion 13B (a node close to the supporting portion 13C) to the exciting unit 15-fixed position be set to a length corresponding to a half of the supporting length L (L1≅L/2) when a generated vibration is the fundamental oscillation, that is, when L=λ/2, in which λ represents the wavelength of the vibration, and the supporting length L represents the length between two supporting portions 13C and 13D.

A yoke member, a magnet, a coil rolled on a magnet core or the like (all are not shown) are provided in a case covering the exciting unit 15. For example, the yoke member and the magnet form a magnetic path, and the magnet core and the coil are elastically supported. Therefore, if electric current flows in the coil, a magnetic driving force is generated by the magnetic field forming the magnetic path and the electric current, the magnetic core and the coil vibrate in the Z1-Z2 direction of the drawings.

Meanwhile, the exciting unit 15 is not limited to a unit using a magnetic driving force like the above, and, for example, an exciting unit that has a piezoelectric vibrator for vibrating can be used as the exciting unit 15.

The control unit 17 includes a CPU, a storage unit, a calculation unit, and various interfaces or the like.

Next, the operation of the input device 10 of the invention will be described on the basis of the circuit block diagram of FIG. 1.

The control unit 17 displays predetermined images on the display unit 14 by outputting predetermined display data. In addition, the control unit 17 monitors the state of the detecting unit 13 at all times. More specifically, the control unit 17 applies a predetermined voltage to the detecting unit 13 at constant cycles and detects the variation of resistance, capacitance or the like generated by an input operation on the display region 13A with voltage variation. When an operator presses the display region 13A, the coordinate-detecting unit 13b of the detecting unit 13 detects the coordinate data of the pressed regions. The control unit 17 can scan the coordinate data from the coordinate-detecting unit 13b.

The control unit 17 scans the coordinate data and outputs starting signals S1 to the driving unit 16 when it is determined that the operator presses the display region 13A. When receiving the starting signals S1, the driving unit 16 generates driving signals Sd consisting of natural resonance frequencies of the detecting unit 13 (particularly, the surface panel 13a) and outputs the driving signals Sd to the exciting unit 15. In this case, since the exciting unit 15 generates vibrations, and the vibrations drive the surface panel 13a of the detecting unit 13, a click sensation (operating feeling) is transmitted to the operator through the surface panel 13a. Furthermore, the click sensation is the response to the input operation.

In the invention, the exciting unit 15 is disposed at a position of a predetermined length L1(=L/2) away from the supporting portion 13C in the rear side of the free-end portion 13B of the detecting unit 13. That is, the exciting unit 15 is disposed at a position close to the antinode of the vibration wave of the detecting unit 13 (particularly, surface panel 13a) as shown by the dotted lines and arrows in FIG. 4. In addition, even when the detecting unit 13 generates vibrations at the free-end portion 13B, a force regulating the vibrations rarely is exerted on the free-end portion 13B, thereby the free-end portion 13B can efficiently vibrate, forming the node of the vibration at the supporting portion 13C and the antinode of the vibration at the free-end portion 13B. Furthermore, when the free-end portion 13B vibrates like the above, vibrations forming nodes at the supporting portions 13C and 13D and an antinode between the nodes can be generated at the display region 13A connected with the free-end portion 13B.

Therefore, compared with the input device in the related art, in which the exciting unit 15 is disposed at a position close to the node of the vibration wave, large-amplitude vibrations can be generated by a small driving force. As a result, the operator can securely feel vibrations (click sensation) as a response to a pressing operation (input operation).

Furthermore, since the resonance frequency of the exciting unit 15 is set to correspond with the resonance frequency of the driving unit 13, particularly, the surface panel 13a, large-amplitude vibrations can be generated with a small driving force by conforming the frequencies of the driving signals Sd to the resonance frequency. Therefore, it is possible to decrease the size of the exciting unit and to suppress the power consumption of the exciting unit. That is, vibrations can be efficiently generated.

Even though the exciting unit 15 provided at the outside of the supporting portion 13C of the detecting unit 13 in the X1-direction of the drawings has been described so far, the exciting unit 15 of the invention is not limited to be disposed at the outside of the supporting portion in the X1-direction of the drawings, and the exciting unit 15 can be provided at the outside of the supporting portion 13C in the X2-direction of the drawings. In addition, the exciting units 15 can be provided at the outsides of the supporting portion 13C in the X1 and X2-directions of the drawings.

Meanwhile, although the input device using the fundamental oscillation (λ=2L) has been described in the above embodiment, the invention is not limited thereto. For example, as shown in FIG. 5, when double oscillation is used (λ=L), that is, when the number n of vibration nodes formed between the supporting portions 13C and 13D is two, it is preferable to set the length L1 at a position corresponding to ¼ of the supporting length L (L1≅L/4), and when triple oscillation is used (λ=2L/3), that is, when the number n of vibration nodes is three, it is preferable to set the length L1 at a position corresponding to ⅙ of the supporting length L (L1≅L/6). That is, when n-times oscillation is used (λ≅2L/n; n is an integer), that is, when the number of vibration nodes formed between the supporting portions 13C and 13D is n, it is preferable to set the length L1 at a position corresponding to 1/(2n) of the supporting length L (L1≅L/(2n)), and then large-amplitude vibrations can be generated for all vibrations by maintaining the above relationship.

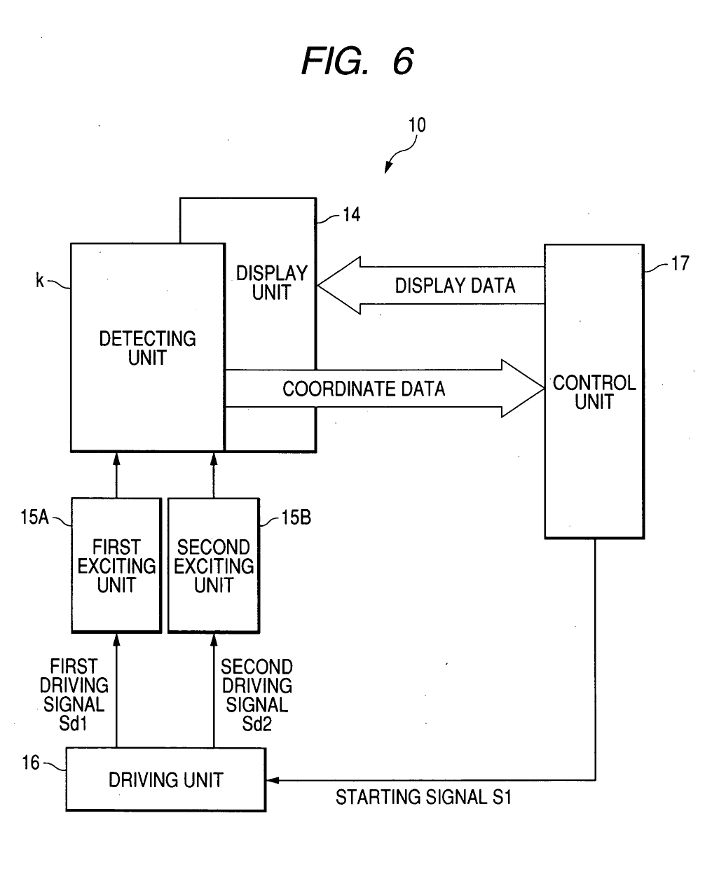

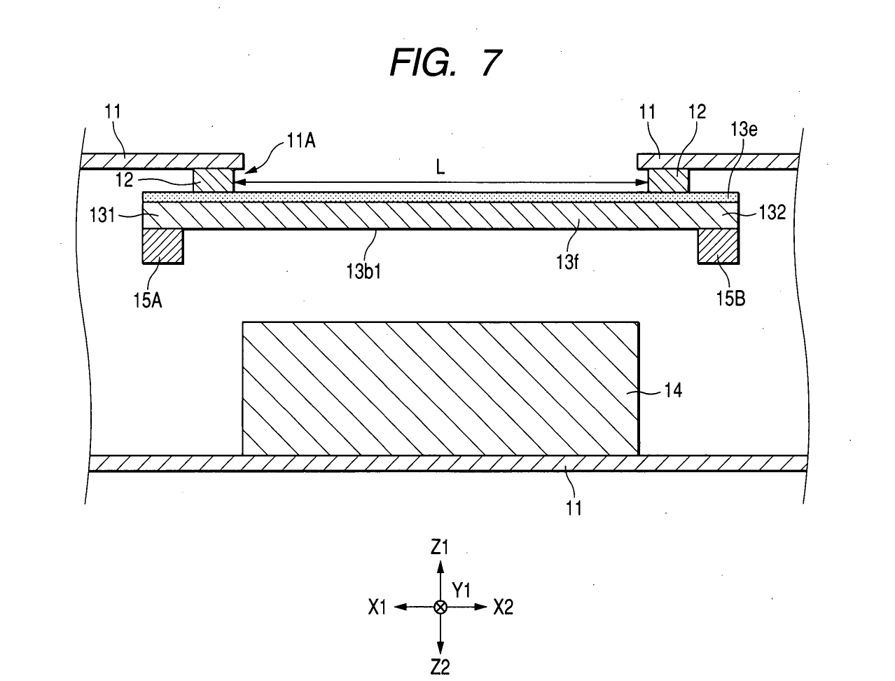

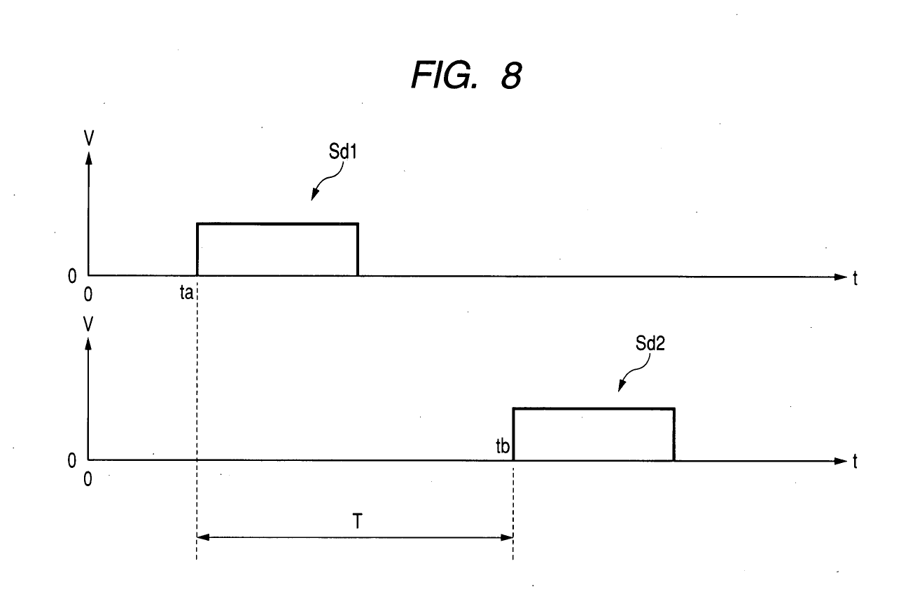

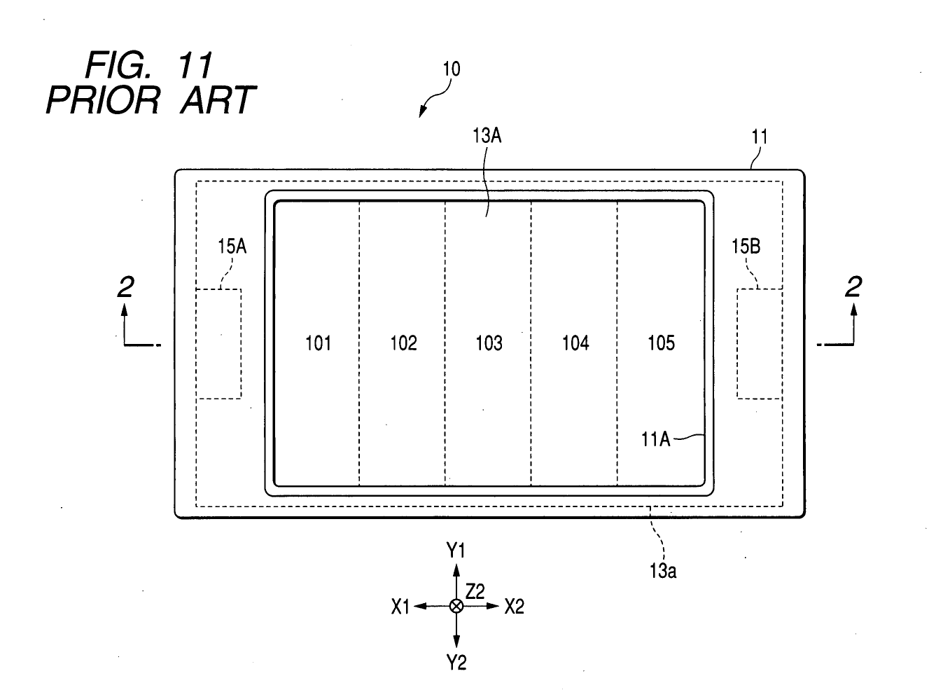

FIG. 6 is a block diagram showing the composition of a second embodiment of the input device according to the present invention, FIG. 7 is a cross-sectional view of the input device of the second embodiment taken along line 2-2 in FIG. 11, and FIG. 8 is a view showing driving signals fed to a vibration-generating unit of the second embodiment. Meanwhile, the abscissa t represents time and the ordinate V represents the voltage of the driving signals in FIG. 8.

The input device 10 of the second embodiment is used for, for example, a display of a car navigation system showing a map or the like. In addition, the input device 10 is used for an operating panel of domestic electronic machine, an office electronic machine or the like.

As shown in FIG. 6, the input device 10 includes detecting unit K provided at the surface panel 13 such as a so-called touch panel or the like, display unit 14 displaying images or the like, first exciting unit 15A, second exciting unit 15B, driving unit 16 driving both exciting units 15A and 15B, control unit 17 or the like.

As shown in FIG. 11, the input device 10 includes the chassis 11, and a rectangular, for example, opening 11A is formed at the chassis 11. The surface panel 13 is provided at the lower surface of the chassis 11 (the surface in the Z2-direction of the drawings), and the display region 13A, a part of the surface panel 13, is exposed through the opening 11A.

As shown in FIG. 7, the surface panel 13a includes upper sheet 13e and a lower substrate 13f, and is optically transmittable.

The upper sheet 13e is made of synthesized resin such as transparent polyethylene terephthalate or the like so as to have plasticity, and an upper resistive film is formed with a predetermined thickness of an ITO (Indium Tin Oxide) throughout the lower surface of the upper sheet 13e by sputtering, vacuum evaporation or the like. A pair of upper electrodes made of silver is formed at the Y1 and Y2-side edges of the drawings on the upper resistive film parallel in the Y1 and Y2-directions of the drawings with a space therebetween.

The lower substrate 13f is a transparent glass substrate, and a lower resistive film made of ITO is formed with a predetermined thickness at a predetermined region on the upper surface of the lower substrate 13f (the surface in the Z1-direction of the drawings) like the upper resistive film. A pair of lower electrodes made of silver is formed at the X1 and X2-side edges of the drawings on the lower resistive film parallel in the X1 and X2-directions of the drawings with a space therebetween.

The upper sheet 13e is combined with the lower substrate 13f to face each other with the upper resistive film and the lower resistive film facing each other. Furthermore, the upper resistive film, the upper electrode, the lower resistive film, and the lower electrode compose the detecting unit K.

Elastic supporting members 12 made of rubber or the like are provided at the circumferential edge of the opening 11A in the lower surface of the chassis 11, and the surface panel 13a is fixed to the lower surfaces of the elastic supporting members 12. That is, the detecting unit 13 is elastically supported by the opening 11A through the elastic supporting members 12.

In addition, the display region 13A is exposed to the outside through the opening 11A of the chassis 11, thereby an operator can press the surface panel 13a in the display region 13A with an operating body such as a finger, an operating pen or the like.

For example, if an operator presses down the upper sheet 13e of the surface panel 13a corresponding to the display region 13A with an operating pen, not shown in the drawings, the upper sheet 13e curves downward, and the upper resistive film of the upper sheet 13e touches the lower resistive film of the lower substrate 13f. In this case, the control unit 17 applies voltage a plurality of times to the upper electrodes of the upper sheet 13e and to the lower electrodes of the lower substrate 13f alternately at predetermined intervals. When voltage is applied to the upper electrodes of the upper sheet 13e, the coordinate data of the operating pen in the Y1-Y2 direction of the drawings is detected from the touching point between the upper resistive film of the upper sheet 13e and the lower resistive film of the lower substrate 13f and the resistance ratio of the upper electrodes of the upper sheet 13e. Similarly, when voltage is applied to the lower electrodes of the lower substrate 13f, the coordinate data of the operating pen in the X1-X2 direction of the drawings is detected from the touching point and the resistance ratio of the lower electrodes of the lower substrate 13f. Then, the coordinate position of the operating pen in the XY plane on the display region 13A is detected.

The display unit 14 composed of FPD (flat panel display) or the like is disposed below the display region 13A with a predetermined space away from the lower substrate 13f. As shown in FIG. 1, when the control unit 17 supplies various display data to the display unit 14, the display unit 14 displays images on the basis of the display data. In addition, the images displayed on the display unit 14 can be seen from the outside through the display regions 13A. Therefore, the operator can press the display regions 13A (input operation) while checking the images seen through the surface panel 13a.

In the lower surface 13b1 of the lower substrate 13f of the surface panel 13a, the first exciting unit 15A is fixed to the X1-side edge 131 of the drawings located at the outside of the portion elastically supported by the elastic supporting member 12, and the second exciting unit 15B is fixed to the X2-side edge 132 of the drawings. That is, the first and second exciting units 15A and 15B are disposed symmetrically, as shown in FIG. 5.

The yoke member, magnet, coil rolled on a magnet core or the like (all are not shown) are provided in a case covering the exciting units 15A and 15B. For example, the yoke member and the magnet form a magnetic path, and the magnet core and the coil are elastically supported in the exciting units 15A and 15B. Therefore, if electric current flows in the coil, magnetic field forming the magnetic path and the electric current form a magnetic driving force, the magnetic core and the coil vibrate in the Z1-Z2 direction of the drawings.

Meanwhile, the exciting units 15A and 15B are not limited to a unit using a magnetic driving force like the above, and, for example, an exciting unit that has a piezoelectric vibrator for vibrating can be used as the exciting units 15A and 15B.

The control unit 17 includes CPU, storage unit, calculation unit, various interfaces or the like.

Next, the operation of the input device 10 of the invention will be described on the basis of the circuit block diagram of FIG. 6.

The control unit 17 displays predetermined images on the display unit 14 by outputting predetermined display data. In addition, the control unit 17 monitors the state of the detecting unit K of the display panel 13 at all times. Specifically, the control unit 17 applies a predetermined voltage to the detecting unit K at constant cycles and detects the variation of resistance, capacitance or the like generated by an input operation on the display region 13A with voltage variation. When an operator presses the display region 13A, on the basis of the above principle, the coordinate-detecting unit 13b of the detecting unit 13 detects the coordinate data of the pressed regions. The control unit 17 can scan the coordinate data from the detecting unit K.

The control unit 17 scans the coordinate data and outputs starting signals S1 to the driving unit 16 when determining the operator presses the display region 13A. As shown in FIG. 3, when receiving the starting signals S1, the driving unit 16 generates first driving signals Sd1 having predetermined frequencies at the time of ta and outputs the first driving signals Sd1 to the first exciting unit 15A. And then, the driving unit 16 generates second driving signals Sd2 having predetermined frequencies at the time of tb and outputs the second driving signals Sd2 to the second exciting unit 15B after the delay time T elapses.

The first and second driving signals Sd1 and Sd2 are continuously outputted for a short time at predetermined frequencies, therefore the first and second exciting units 15A and 15B generate vibrations for a short time when receiving the driving signals.

The first exciting unit 15A generates vibrations on the basis of the above principle, and the second exciting unit 15B generates vibrations on the basis of the above principle after the delay time T(=tb−ta) elapses. In addition, the vibrations generated by the exciting units 15A and 15B are transmitted to the surface panel 13a as a wave, and thus a click sensation (operating feeling) is fed to the operator through the surface panel 13a as a response to an input operation.

In the invention, the first driving signals Sd1 are outputted to the first exciting unit 15A in order for the first exciting unit 15A to vibrate, and then, the second driving signals Sd2 are generated and outputted to the second exciting unit 15B in order for the second exciting unit 15B to vibrate after the delay time T elapses. That is, the first and second driving signals Sd1 and Sd2 are generated with time differentiation, and the first and second exciting units 15A and 15B are made to vibrate with time differentiation. Therefore, the phases of vibrations generated by the first and second exciting units 15A and 15B and transmitted to the surface panel are staggered, and the nodes and antinodes are dispersed properly in the waves of vibrations, thereby the waves of the vibrations are securely transmitted throughout the surface panel 13a. As a result, the operator can feel a click sensation throughout the surface panel 13a as a response to an input operation on the surface panel. Meanwhile, in the above case, the exciting units 15A and 15B do not need to be provided symmetrically, and the first exciting unit 15A can be provided at an edge intersecting perpendicularly with the edges of the surface panel, at which the second exciting unit 15B is provided, as described below.

In addition, in the invention, it is preferable that the delay time T be in the range of t0/2≦T≦t0, in which t0 represents the time (delay time) required for the wave of vibrations generated by the first exciting unit 15A to travel to the X2-side edge 132 of the surface panel of the drawings, that is, the edge of the surface panel 13a facing the edge, to which the first exciting unit 15A is fixed. When the delay time T is set like the above, the waves of the vibrations generated by the first and second exciting units are transmitted more securely throughout the surface panel 13a. As a result, the operator can feel a click sensation throughout the surface panel 13a as a response to an input operation on the surface panel 13a.

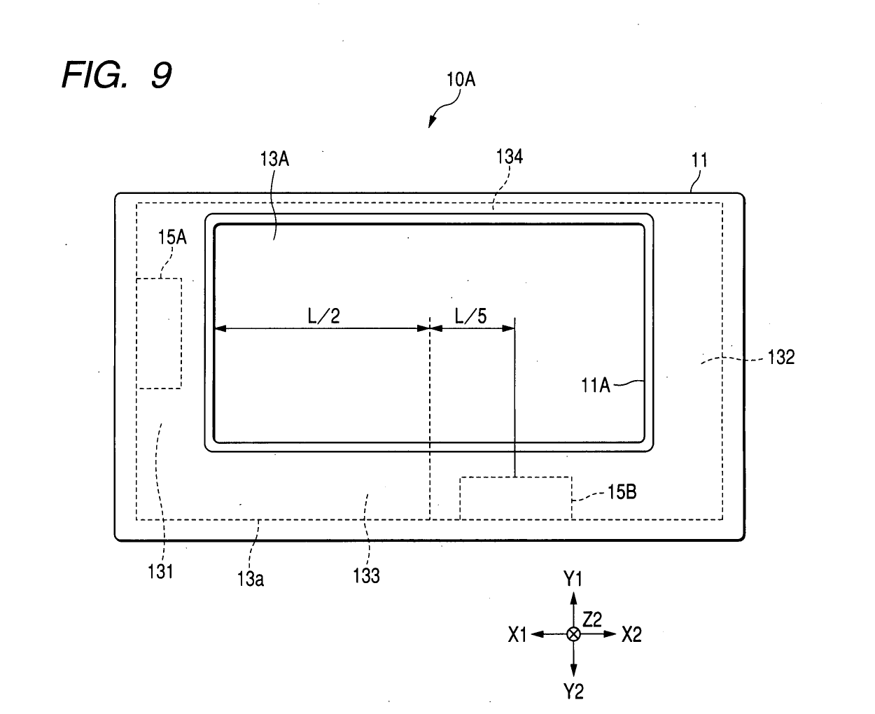

FIG. 9 is the same plane view as FIG. 11, showing a varied embodiment of the input device of the second embodiment.

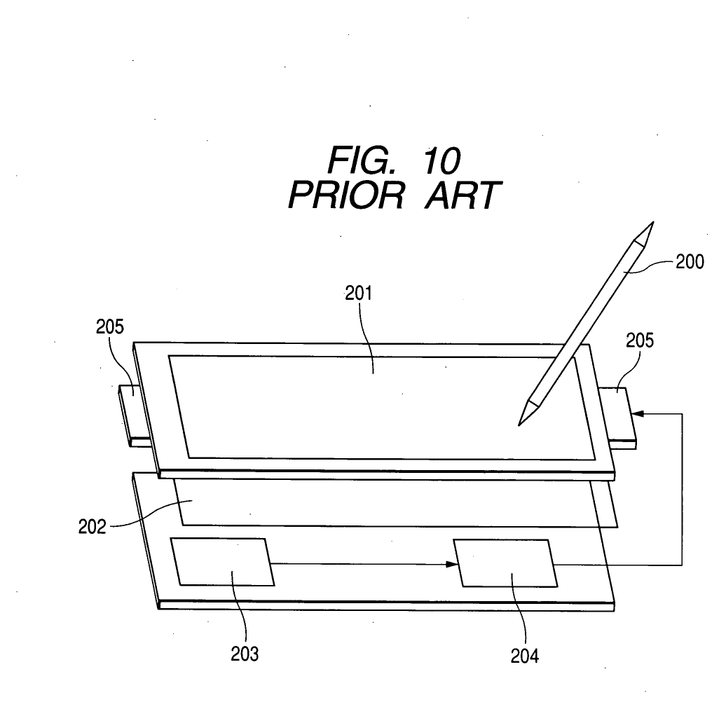

In FIG. 9, since the same signs are attached to the same members as those of the input device 10 shown in FIG. 10, the description will be omitted.

In the input device 10A of the varied example, different from the input device 10, the second exciting unit 15B is provided at the Y2-side edge 133 of the drawings (long edge side) located at the outside of the portion elastically supported by the elastic supporting member 12 in the lower surface 13b1 of the lower substrate 13f of the surface panel 13a as shown in FIG. 9. That is, the second exciting unit 15B is not provided symmetrically to the first exciting unit 15A, and the second exciting unit 15B is provided perpendicular to the edge 131, the short edge, at which the first exciting unit 15A is provided, and fixed to a portion a predetermined length, preferably L/5 (L is the size of the display region 13A in the X1-X2 direction of the drawings), away from the central portion of the edge 133 to the X1 or X2-side.

With the above composition, the waves of the vibrations generated by the first and second exciting units 15A and 15B interfere with each other, and the waves of the vibrations are securely transmitted throughout the surface panel 13a even when the first driving signals Sd1 of the first exciting unit 15A and the second driving signals Sd2 of the second exciting unit 15B are generated at the same time so as to drive the exciting units 15A and 15B at the same time like the input device in the related art of FIG. 10, or when the first driving signals Sd1 of the first exciting unit 15A and the second driving signals Sd2 of the second exciting unit 15B are generated with time differentiation so as to drive the exciting units 15A and 15B with time differentiation as shown in FIG. 8.

In addition, in the above case, it is preferable that the second exciting unit 15B be fixed to the X2-side half of the edge 133 of the surface panel 13a of the drawings from the central portion, that is, to a portion a predetermined distance away from the central portion of the edge 133 to the edge 132 facing the edge 131 of the surface panel 13a, to which the first exciting unit 15A is fixed.

With the above composition, the waves of the vibrations generated by the exciting units 15A and 15B are transmitted more securely throughout the surface panel 13a. As a result, the operator can feel a click sensation throughout the surface panel 13a as a response to an input operation on the surface panel.

Meanwhile, in the above case, the second exciting unit 15B can be provided at the Y1-side edge 134 of the drawings, not at the Y2-side edge 133 of the surface panel 13a of the drawings.

In addition, in the invention, the first exciting unit 15A can be fixed to the X2-side edge 132 in the drawings, not to the X1-side edge 131 of the surface panel 13a of the drawings. In this case, it is preferable that the second exciting unit 15B be fixed to the Y2-side edge 133 of the surface panel 13a of the drawings or to a portion at a predetermined distance away to the X1-side of the drawings from the central portion of the Y1-side edge 134 of the drawings.

It is also preferable that the first exciting unit 15A be provided at the Y2-side edge 133 of the surface panel 13a of the drawings and the second exciting unit 15B be fixed to the X1-side edge 131 of the surface panel 13a of the drawings or to a portion at a predetermined distance away to the Y1-side of the drawings from the central portion of the X2-side edge 134 of the drawings. Furthermore, it is also preferable that the first exciting unit 15A be provided at the Y1-side edge 134 of the surface panel 13a of the drawings and the second exciting unit 15B be fixed to the X1-side edge 131 of the surface panel 13a of the drawings or to a portion a predetermined distance away to the Y2-side of the drawings from the central portion of the X2-side edge 132 of the drawings.

The input device according to the invention can generate large-amplitude vibrations, which can be felt throughout the touch panel as a response to an input operation, efficiently.

1. An input device comprising:
a chassis having an opening;
a detecting unit that has a surface panel exposed through the opening and detects a pressing operation when the surface panel is pressed;
an exciting unit that vibrates the surface panel;
a driving unit that generates driving signals driving the exciting unit at predetermined frequencies; and
a control unit that supplies starting signals starting the driving unit on the basis of an output from the detecting unit,
wherein the detecting unit is supported by two supporting portions provided at edge portions of the opening and has a free-end portion at the outside of one of the supporting portions and the exciting unit provided at the free-end portion.

2. The input device according to claim 1,
wherein a length L1 from the exciting unit-fixed position to a closer node is set to 1/(2n) of a supporting length L, L represents the supporting length between the two supporting portions, and a natural number n represents the number of antinodes of vibration formed between the supporting portions.

3. The input device according to claim 2,
wherein the vibration forms nodes at the supporting portions provided at edge portions of the opening and an antinode between the supporting portions and the length L1 be set a half of the supporting length L.

4. The input device according to claim 1,
wherein the free-end portion is formed by integrally extending the surface panel.

5. The input device according to claim 1,
further comprising a display unit that is provided at a position facing the detecting unit in the chassis.

6. The input device according to claim 1,
wherein the detecting unit has a coordinate-detecting unit that detects coordinate data of pressed regions when an operator presses the surface panel and the exciting unit is driven when the control unit scans the coordinate data from the coordinate-detecting unit.

7. The input device according to claim 1,
wherein a resonance frequency of the exciting unit is set the same as a resonance frequency of the surface panel.

8. An input device comprising:
a chassis having an opening;
a detecting unit that has a surface panel exposed through the opening and detects a pressing operation when the surface panel is pressed;
a first exciting unit that vibrates the surface panel;
a driving unit that generates driving signals driving the first exciting unit at predetermined frequencies; and
a control unit that supplies starting signals starting the driving unit on the basis of the output from the detecting unit, wherein the detecting unit is supported by two supporting portions provided at the edge portions of the opening and has a free-end portion at the outside of one of the supporting portions, the first exciting unit provided at the free-end portion, and a second exciting unit is provided to vibrate the surface panel.

9. The input device according to claim 8, wherein the second exciting unit is provided at the free-end portion outside the supporting portion.

10. The input device according to claim 8,
wherein the driving unit generates first driving signals driving the first exciting unit and second driving signals driving the second exciting unit, the first and second driving signals are generated with time differentiation, and the control unit is provided to drive the first and second exciting units with time differentiation.

11. The input device according to claim 8,
wherein the surface panel is rectangular, the first exciting unit is disposed along one of two end sides intersecting each other perpendicularly in the surface panel, and the second exciting unit is disposed along the other end side.

12. The input device according to claim 8,
wherein the surface panel has long and short sides, the first exciting unit is disposed along the short side, and the second exciting unit is disposed along the long side and away from the first exciting unit at a center of the long side.

13. The input device according to claim 10,
wherein the second driving signals are generated when a predetermined delay time T elapses after the first driving signals are generated and the delay time T is in the range of t0/2≦T≦t0, in which t0 represents a time required for a wave, which is generated by the first exciting unit driven by the first driving signals and transmitted to the surface panel from the first exciting unit, to travel from ate first exciting unit-provided end at the side to an opposite end side thereof.
